(19) United States
(12) Patent Application Publication
(10) Pub. No.: US 2014/0095078 A1
(43) Pub. Date: Apr. 3, 2014

(54) METHOD AND SYSTEM FOR PRESENTING SEISMIC INFORMATION

(71) Applicant: Ruxar Software Solutions AS, Stavanger (NO)

(72) Inventors: Garrett Leahy, Stavanger (NO); Tyson Bridger, Stavanger (NO); Erik Nilsen, Oslo (NO); Alexander Bukhgeym, Oslo (NO)

(73) Assignee: Ruxar Software Solutions AS, Stavanger (NO)

(21) Appl. No.: 14/096,573

(22) Filed: Dec. 4, 2013

(30) Foreign Application Priority Data
Jun. 12, 2012 (NO) 20121472

(51) Int. Cl. G01V 1/34; G01V 1/30

(52) U.S. Cl. CPC G01V 1/345; G01V 1/30
USPC 702/16

(57) ABSTRACT

The present invention relates to a method for presenting seismic information sampled from geological formations, including the steps of sampling information from a chosen geological formation representing at least one parameter related to the formation, analyzing the sampled information from said geological formation producing a measure of the uncertainty related to said at least one parameter, and thereby defining a geobody related to said uncertainty of the at least one parameter being less than a predetermined limit.

### BACKGROUND

1. Field of the Invention

This invention relates to a method and system for presenting seismic information sampled from geological formations.

2. History of the Related Art

Seismic studies represent an important means for mapping geological formations, for example for finding hydrocarbon resources or water reservoirs, by transmitting vibrations into the formations and detecting their reflections and refraction and in some cases transformations from pressure waves to shear waves.

These studies include large amounts of data using complex algorithms to provide a three dimensional map of the geological formations, where each point in the map calculated based on the seismic data. After this process the operators interpret the map manually and based on their knowledge try to detect the promising geological structures possibly containing hydrocarbons or other resources.

Conventional workflows for interpretation of the geophysical data capture a single model of subsurface structure. However, geophysical data are not exact, but are subject to variations in the quality of the sampling process, e.g. in the position of the seismic sensors, their sensitivity and other sources disturbing the seismic signals.

The field of subsurface interpretation and model building has been an area of active interest for many years. For example, Barringer (U.S. Pat. No. 477,633) discloses a method for illustrating a geologic formation in the subsurface using blocks. Others, including Ricker (U.S. Pat. No. 2,354,548) and Zuschlag (U.S. Pat. No. 2,241,874) describe methods for acquisition and interpretation of seismic energy as it is reflected from subsurface formations.

As technology developed, further interpretation techniques were proposed to help quantify subsurface properties. Prior art is abundant in this field, and includes examples such as Quay (U.S. Pat. No. 3,668,618), who discloses a method for identifying changes in velocity properties based on the mapped geometry of reflection horizons; and Nelson and Lehnhardt (U.S. Pat. No. 3,512,131) who disclose a method for displaying seismic data on a computer.

Seismic interpretation in particular requires a high degree of manual input and cannot be easily automated. This is because it is difficult to design algorithms to determine between changes in geologic structure (that are not known a priori) and changes due to poor data quality. Further, as sedimentary structures are frequently layered and repeating sequences, when presented with an abrupt change (for example, a fault), it is not always obvious how to map the surface. Many algorithms have been developed (see for example, Hildebrand, U.S. Pat. No. 5,153,858 or U.S. Pat. No. 5,432,751) that attempt to solve these challenges.

An area of more recent research revolves around the uncertainty associated with a particular interpretation. Uncertainty can be categorized as either measurement uncertainty (non-uniqueness) or scenario uncertainty (configurational or conceptual uncertainty). Bond et al 2007, Tegtmeier et al. “The determination of interpretation uncertainties in subsurface representations”, Rock Mechanics Data: Representation & Harmonization, specialized session S02, 11^{th} ISRM Congress, Lisbon 2007, and Houck et al 1999 describe in detail challenges associated with scenario uncertainty and propose possible solutions, which are not the subject of the present invention.

Measurement uncertainty can take two forms. First, how precisely can an individual interpreter place a measurement of a geobody's location in the subsurface, wherein a geobody may be a geological formation, fault line etc, and second, how much variability in said measurement is tolerated by the data. While it is well established that geophysical data are non-unique and can support multiple interpretations, current methods for assessing this uncertainty suffer from a variety of different shortcomings.

Zahuckzi (2007) discusses structural uncertainty related to a hydrocarbon reservoir. He mentions four methods to obtain measurement (“picking”) uncertainty. Unfortunately, the method he proposes does not allow the interpreter to simultaneously capture uncertainty during the mapping of a geobody. He proposes a mathematical proxy for estimating uncertainty from seismic energy; however this method is not based on the underlying physics and therefore can misrepresent the actual uncertainty supported by the data. He also proposes presuming uncertainty relative to a known measurement at a well; but this method does not permit for changing geologic structure as the interpreter moves away from the well. Finally he suggests performing interpretation of the seismic data with several interpreters, however this is in essence a posteriori uncertainty estimation, and the method does not allow the interpreter to simultaneously measure and map uncertainties and geobody locations.

In another example, Wellmann and Regenauer-Lieb: “Effect of geological data quality on uncertqainties in Geological models and subsurface flow fields”. Proceedings, Thirty-Seventh Workshop on Geothermal Reservoir Engineering, Stanford, Calif., Jan. 30-Feb. 1, 2012 disclose a method in which measurement uncertainty is assigned to a subsurface model. Unfortunately, their method assumes that the uncertainty distribution has a fixed shape that varies with depth, and does not permit the interpreter to determine the uncertainty while mapping subsurface features. Tacher et al 2006 also disclose a method for associating uncertainty with 3D models; however their method also does not allow the interpreter to determine the uncertainty during the interpretation phase.

Another class of methods for estimating uncertainty in structural models revolves around using simulations and inversions to estimate the amount of error tolerated by the data. For example, Malinverno et al (U.S. Pat. No. 6,549,854) disclose a method for updating a subsurface model and uncertainty estimate that combines an initial model and uncertainty estimate with measured data and a forward simulator. While the method requires a prior uncertainty distribution for the initial model, unfortunately, the authors do not disclose a method for how to measure and collect this uncertainty information. Gunning et al (U.S. Pat. No. 7,254,091) disclose a method for estimating uncertainty from seismic data. However, this method requires the results of an inversion, information regarding observed faults, and information from well logs. Further, the uncertainty is estimated based on posterior analysis of a set of randomly generated realizations, not measured during interpretation. Jones et al (U.S. Pat. No. 5,838,634) disclose a method for obtaining a geologic model subject to geophysical constraints (inversion and optimization).

Bruun et al (US2010/0332139) disclose a system for building a geologic model that makes use of uncertainty information. Their method requires seismic data including travel time uncertainty and a velocity model including velocity uncertainty. Unfortunately, they do not teach how these uncertainties might be measured via interpretation.

Dobin (US2012/0150449) discloses a system for estimating uncertainty during interpretation. Unfortunately, this system captures the physiological response of the interpreter, not the interpreter's direct thoughts on the uncertainty. The intepreter's physiologic response may be biased (the interpreter thinks he/she is correct when in fact they are making an error) or reflect external stimulus (stress, environment, etc).

Thus a seismic data set can generally support an infinite number of interpretations that satisfy the data to within a particular tolerance. Because of this, decisions are made with a poor understanding of potential errors or uncertainty in the interpretation. In order to more effectively manage geologic risk, an improved method is required.

WELLMANN, J. F. et al.: “Towards incorporating uncertainty of structural data in 3D geological inversion”. Tectonophysics 490 (2010), pages 141-151, describes a method describes for inversion of subsurface data to obtain and characterize uncertainty on subsurface data. In this method, an initial guess of the model is constructed; uncertainties on key parameters are defined; then, these are used to generate guesses of possible structure. These model realizations are used to generate simulated data; uncertainty is finally determined as the range of variability in the realizations permitted while at the same time having the simulated data agree with the measured data to within some precision.

### SUMMARY

Thus it is an object of this invention to provide means for improving the data set used for presenting the seismic studies. This is obtained as specified in the accompanying claims.

Thus a solution is presented that solves the problem stated above by measuring both a best-estimate interpretation of a defined geobody and an associated uncertainty with this interpretation. With this information a simulator can be used to create multiple realizations of a given geobody. These realizations can be used to effectively manage geologic risk.

According to the Wellmann (2010) article referred to above the hey present a method that relates to a method comprising five steps: construction of an initial geological model with an implicit potential-field method, assignment of probability distributions to data positions and orientation measurements, simulation of several input data sets, construction of several model realisations based on these simulated data sets and finally the visualisation and analysis of the uncertainties.

The present invention relates to a method does not require the construction of an initial geological model with an implicit potential field method. Instead, the data is interpreted directly as delivered from for example seismic processing (industry standard data preparation workflow). The present method does not require the simulation of any input data sets. In general the method does not require geophysical datasets to be simulated; the data is used to guide the interpreter. Thus the method according to the present invention does not require the construction of model realizations based on simulated data sets. The method presented in Wellmann (2010) determines which model realizations are appropriate based on simulating the input data and using a similarity metric to determine whether the data are adequately reproduced. There is no comparison step or simulation step required in the present method.

### BRIEF DESCRIPTION OF THE DRAWINGS

The invention will be described below with reference to the accompanying drawings, illustrating the invention by way of examples.

FIGS. 1a-1d illustrates the definition of a geobody according to the invention as well as the use thereof.

FIG. 2 illustrates the process including the use of the geobody for interpretation.

### DETAILED DESCRIPTION

Interpretation is performed in general on seismic data, and this invention pertains mainly to the interpretation of seismic data. However, this invention is generally applicable to the interpretation of all data or maps of the subsurface.

In conventional seismic interpretation, the user aims to map horizons and faults in the subsurface. This is achieved by the user looking at seismic data and marking a point (“pick”) where a reflection of seismic energy may indicate the presence of an impedance contrast (“horizon”) in the Earth. Discontinuities in horizons may reflect structural deformation and can be interpreted as faults. Faults are picked similarly to horizons, where a point is marked where the interpreter believes the fault crosses a horizon.

Technology has progressed to the point where sophisticated algorithms are used to help streamline the process of picking horizons and faults (“auto/ant trackers”). However, these methods tend to fail in the presence of less than ideal data quality or complicated tectonic structure.

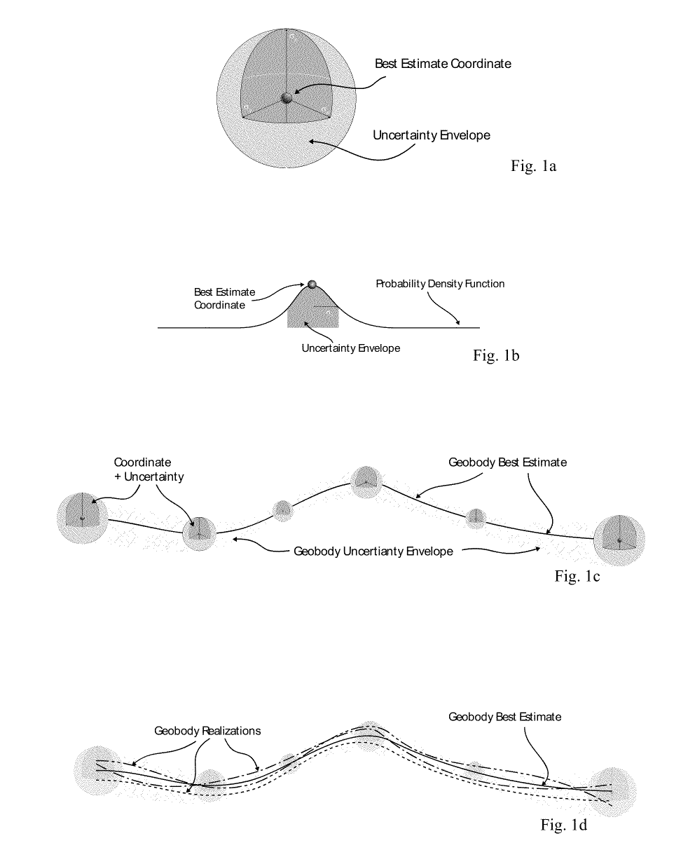

Further, conventional work flows yield at best a single model (“best-estimate”) for subsurface structure as is illustrated in FIGS. 1a and 1b. Unfortunately, it is widely established that there is uncertainty inherent in the data. For example, with a conventional seismic bandwidth it is impossible to determine interface locations in time to more than ˜1/30 seconds. This may translate into uncertainties in the final structural model. These uncertainties are not captured by conventional workflows.

The method according to the invention as illustrated in FIGS. 1a-1d embraces the uncertainty inherent in the data by allowing the user to capture this information simultaneously to making the best-estimate pick. In FIG. 1 a geobody 2 is illustrated surrounding the best estimate coordinate 1. The geobody in FIG. 1a is defined in three, e.g. spatial, dimensions but more complex models may also be contemplated referring to other parameters such as vectors in shear waves. In addition the geobody 2 in FIG. 1a is illustrated as an essentially circular body, but the uncertainty may differ in different directions, thus resulting in other shapes.

As is illustrated in FIG. 1b the uncertainty envelop defining the geobody in one direction may be defined related to a threshold value where the size of the envelop is defined by the reliability of the information being above a chosen threshold. This threshold may also be calculated using other means, e.g. by being related to other features and their uncertainties, percentage of difference from best estimate value or absolute distance from best estimate values.

In FIG. 1c it is evident that the shape and size of the geobody may vary from point to point, e.g. along a geological formation, having varying sizes depending on the uncertainty calculated for each measured point.

The difference in geobodies and their envelops results in several different possible formations, as is illustrated in FIG. 1d. Thus an operator may interpret the data within a range of different formation forms, where the likelyhood of each shape may be calculated. This offers a number of variation possibilities for the operator to use in interpreting the data.

Based on this a software tool may be contemplated where the interpreter uses a “brush” to interpret geobodies (horizons, faults, contacts, etc) in the Earth. The brush width represents the uncertainty in the best-estimate pick, and can be adjusted on-the-fly by the user. The brush shape represents a probability density function that describes the relative probability of possible picks in space and time. Brush shapes can include (but are not limited to) Gaussian functions or boxcar functions.

The width of the brush can be either set manually based on the interpreter's view of possible horizon locations, or can be set automatically based on intrinsic physical properties of the data. For seismic data, the brush size might reflect the peak frequency of the data in a window near the pick; for gravity data or other potential field data the brush size might reflect the sensitivity/resolution kernels at depth.

The advantage of this method is that it permits multiple realizations of geobodies to be generated numerically after the interpretation, reflecting the set of models that may all satisfy the geophysical data. Further, the data can be extended to calculate a suite of structural models and geophysical attributes (volume or horizon) that can then be used to de-risk operational decisions accordingly.

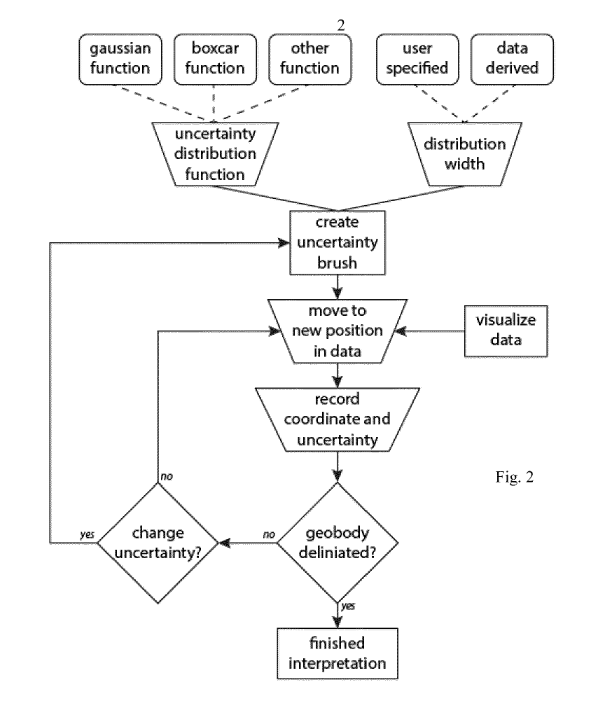

FIG. 2 illustrates the process a brush as described above, where an uncertainty distribution function is may be provided based on a boxcar function, an assumed e.g. a Gaussian distribution or other functions. This may be combined with choices made by a user, e.g. related to understanding of the data sampling as well as the derived data through the process. From this a geobody and corresponding brush may be used to select a new position in the data, e.g. visualized on a screen. The selected coordinates and corresponding uncertainty in the data is recorded and the result may be reviewed by the used with respect to other features in the map, delineation of the geobody etc. If the operator finds the results to be unsatisfactory a new positioned, and possibly uncertainty, may be selected by the operator.

Thus the present invention provides a method for subsurface interpretation of geological formations in which a measurement of coordinate uncertainty is simultaneously captured with an estimate of best-estimate coordinate. This includes a collection of measurements delineating a geobody is made, wherein the coordinate uncertainty and best-estimate coordinate are used to generate a probability density function representing the possible locations of the geobody. The coordinates may refer to lateral position and time coordinate or lateral position and depth in the Earth;

The interpretation is performed using a visualization of geophysical data, where the visualization of geophysical data includes seismic data, e.g. a visualization of geophysical data being a model or estimate of subsurface properties inferred from geophysical measurements. The geophysical data may include multiple varieties of geophysical data being co-rendered and interpreted simultaneously.

As indicated in FIG. 2 the user may control the uncertainty measurement using a tool of specified width and shape (“brush”), the brush may represent a Gaussian distribution with width (in multiples of standard deviation) equal to the interpretation uncertainty, or a box-car distribution with width equal to the interpretation uncertainty, or any arbitrary function representing a probability distribution. The brush width may also be set manually by the user based on experience or other choices not covered by the rest of the system, or, in a preferred embodiment at least partially calculated to represent inherent uncertainty in geophysical data, e.g. the frequency content of the data or the local sensitivity kernel.

A specific realization of a geobody is generated using the measured uncertainty information and best-estimate position as discussed in FIG. 1a, the mapped subsurface structure constituting several independent geobodies. Thus the realization of subsurface structure may be generated using the measured uncertainty information and best-estimate position of all geobodies contained within the region of interest, performed in a computer, possibly assisted by a user through a user interface, e.g. a touch screen, touch pad, computer mouse or similar. The produced map thereby enables the operator to provide interpretations related to the possibility for oil production or similar.

Thus to summarize the invention relates to a method for presenting seismic information sampled from geological formations, including the steps of sampling information from a chosen geological formation representing at least one parameter related to the formation. The sampled information from said geological formation is analysed for producing a measure of the uncertainty related to said at least one parameter and defining an envelope related said uncertainty of the different parameters. This space defines a geobody extending along each parameter dimension, a chosen amount, e.g. defined by being below a chosen uncertainty, the uncertainty being chosen depending on the parameter and situation.

The parameters may preferably relate to a measurement of a best-estimate coordinate and the uncertainty related to the coordinate uncertainty is simultaneously captured with an estimate of coordinate. The coordinate uncertainty and best-estimate coordinate are used to generate a probability density function representing the possible locations of the geobody.

The coordinate may refer to lateral position and time coordinate of sampled seismic data, or lateral position and depth in the Earth, e.g. sampled from wells. Depth information from wells may thus present less uncertainty and therefore be used to produce less space for variation in that dimension.

The visualization geophysical data including seismic data may be performed on computer screens, prints etc, and may be represented by a model or estimate of subsurface properties inferred from geophysical measurements. In the visualization multiple varieties of geophysical data may be co-rendered and interpreted simultaneously.

The system for executing the method accosting to the invention may also include a user interface, e.g. for allowing the user to choose the predetermined value or in other ways adjust or monitor the data. As an example the user may include new measurements from a well bore which reduces the uncertainty of some of the data.

The predetermined value may be represented by a Gaussian distribution with width (in multiples of standard deviation) equal to the interpretation uncertainty, a box-car distribution with width equal to the interpretation uncertainty, or any arbitrary function representing a probability distribution. It may also be calculated to represent inherent uncertainty in geophysical data, be represented by the predetermined value is related to the frequency content of the data, or be related to the local sensitivity kernel.

The method according to the invention may be used for modeling of geologic or subsurface structures to map subsurface structure made up of several independent geobodies, where a specific realization of subsurface structure is generated using the measured uncertainty information and best-estimate position of all geobodies contained within the region of interest;

1. Method presenting seismic information sampled from geological formations, including the steps of sampling information from a chosen geological formation representing at least one parameter related to the formation, analyzing the sampled information from said geological formation producing a measure of the uncertainty related to said at least one parameter, and thereby defining a geobody related to said uncertainty being below a chosen limit.

2. Method according to claim 1, wherein said parameters relate to a measurement of a best-estimate coordinate and the uncertainty is related to the coordinate uncertainty simultaneously captured with an estimate of coordinate.

3. Method according to claim 2 in which the coordinate uncertainty and best-estimate coordinate are used to generate a probability density function representing the possible locations of the geobody.

4. Method according to claim 2, in which the coordinate refers to lateral position and time coordinate.

5. Method according to claim 2 in which the coordinate refers to lateral position and depth in the Earth;

6. Method according to claim 1, wherein the parameters related to the geobody mappings are made based on a visualization of geophysical data.

7. Method according to claim 6 in which the visualization of geophysical data includes seismic data or seismic attribute data.

8. Method according to claim 6 in which the visualization of geophysical data is a model or estimate of subsurface properties inferred from geophysical measurements;

9. Method according to claim 6 in which multiple varieties of geophysical data are co-rendered and interpreted simultaneously;

10. Method according to claim 1 in which the predetermined uncertainty value is chosen through a user interface.

11. Method according to claim 10 wherein the predetermined value is represented by a Gaussian distribution with width (in multiples of standard deviation) equal to the interpretation uncertainty;

12. Method according to claim 10 wherein the predetermined value is a box-car distribution with width equal to the interpretation uncertainty;

13. Method according to claim 10 wherein the predetermined value is any arbitrary function representing a probability distribution;

14. Method according to claim 10 wherein the predetermined value is calculated to represent inherent uncertainty in geophysical data;

15. Method according to claim 10 wherein the predetermined value is related to the frequency content of the data;

16. Method according to claim 10 wherein the predetermined value is related to the local sensitivity kernel;

17. Method for modeling of geologic or subsurface structures, comprising using a method of claim 1 to map subsurface structure made up of several independent geobodies;

18. Method according to claim 17 wherein a specific realization of subsurface structure is generated using the measured uncertainty information and best-estimate position of all geobodies contained within the region of interest;
